(19) United States
(12) Patent Application Publication
(10) Pub. No.: US 2015/0183196 A1
(43) Pub. Date: Jul. 2, 2015

(54) Clear and Flexible Films Including Polyactic Acid

(71) Applicant: Avery Dennison Corporation, Glendale, CA (US)

(72) Inventor: Vadim ZAIKOV, Perry, OH (US)

(21) Appl. No.: 14/565,728

(22) Filed: Dec. 10, 2014

Related U.S. Application Data
(60) Provisional application No. 61/921,605, filed on Dec. 30, 2013.

(51) Int. Cl. B32B 27/36; B32B 27/08

(52) U.S. Cl. CPC B32B 27/36; B32B 27/08; B32B 2250/02; B32B 2250/03; B32B 2250/244; B32B 2250/40

(57) ABSTRACT

Multilayer film assemblies based upon polylactic acid resin and certain plasticizers are described. The multilayer films are optically clear and flexible.

### CROSS-REFERENCE TO RELATED APPLICATION

The present application claims the benefit of U.S. Provisional Application No. 61/921,605 filed Dec. 30, 2013, which is incorporated by reference herein in its entirety.

### FIELD

The present subject matter relates to optically clear and flexible films formed from polylactic acid (PLA) resins. The present subject matter also relates to multilayer assemblies containing such films.

### BACKGROUND

Films formed from polylactic acid can be optically clear. However, such films typically exhibit a high modulus and thus upon deformation are “noisy.” That is, upon wadding up such a film for example, a relatively loud “crinkling” noise is emitted. Attempts have been made to improve the flexibility of such films and thus reduce such noise, however, a significant loss in film clarity results.

Accordingly, a need remains for a polylactic acid film and particularly for layered assemblies of such films which exhibit a combination of good flexibility and a relatively high level of optical clarity.

### SUMMARY

The difficulties and drawbacks associated with previously known materials are addressed in the present compositions, films, and multilayer assemblies.

In one aspect, the present subject matter provides a multilayer film comprising a first layer that includes polylactic acid (PLA) resin and at least one bio-based plasticizer. The multilayer film also comprises a second layer that includes polylactic acid (PLA) resin and at least one bio-based plasticizer.

In another aspect, the present subject matter provides a multilayer film comprising at least three layers in which each layer includes polylactic acid (PLA) resin and one or more bio-based plasticizers.

In still another aspect, the present subject matter provides a core-skin multilayer film comprising a first skin layer including polylactic acid (PLA) resin and at least one bio-based plasticizer, a second skin layer including polylactic acid (PLA) resin and at least one bio-based plasticizer, and a core layer disposed between the first skin layer and the second skin layer.

The various films described herein exhibit a unique combination of properties of being optically clear or substantially so and exhibiting a relatively high degree of flexibility.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of an embodiment of a multilayer film assembly in accordance with the present subject matter.

FIG. 2 is a schematic cross sectional view of another embodiment of a multilayer film assembly in accordance with the present subject matter.

### DETAILED DESCRIPTION OF THE EMBODIMENTS

The present subject matter provides an optically clear and flexible film comprising polylactic acid (PLA) resin and one or more bio-based plasticizers. The film exhibits a remarkable combination of properties of being optically clear or transparent, or substantially so, and flexible. Generally, the film comprises (i) at least 70% of PLA resin and (ii) 30% or less of one or more bio-based plasticizers. In particular embodiments, the films comprise at least 75% of one or more PLA resin(s) and 25% or less of one or more bio-based plasticizers. All percentages noted herein are percentages by weight unless indicated otherwise.

Polylactic acid (PLA) or polylactide is a thermoplastic aliphatic polyester derived from renewable resources such as from corn starch or sugar cane for example. Polylactic acid has a molecular formula (C₃H₄O₂)ₙ. The terms polylactic acid, polylactide, PLA, and PLA resin are used interchangeably with one another in industry, and so are used synonymously herein. Polylactic acid is commercially available. A particularly useful PLA resin is Polylactide Resin from Natureworks, LLC of Minnetoka, Minn., USA, available under the designation product code 4060D. Several CAS numbers are associated with polylactic acid. PLA resin from Natureworks has a CAS number 9051-89-2. Sigma-Aldrich identifies a PLA resin available from Sigma-Aldrich as having a CAS number 26100-51-6. Other CAS numbers for PLA resins include CAS number 33135-50-1.

There are no particular limitations on the molecular weight of the PLA. In certain embodiments of the present subject matter, the molecular weight of PLA can be between about 10,000 and about 500,000. In particular embodiments, the molecular weight can be about 20,000; 50,000; 100,000; 200,000; 300,000; or 500,000 g/mol or more. There is no particular upper limit for the molecular weight.

The present subject matter also includes the use of multiple PLA resins or grades of PLA resins in the films. For example, in certain embodiments, two or more PLA resins can be combined in a single film or layer. In yet another example, two or more PLA resins can be utilized in individual or separate layers or region of a film or multilayer film assembly.

The films of the present subject matter also comprise one or more bio-based plasticizers. The term “bio-based” as used herein refers to a characteristic of each plasticizer that at least 50% of the components of the plasticizer are derived from biological, renewable sources. In many embodiments, the bio-based plasticizers are at least 75% bio-based, and in other embodiments at least 85% bio-based. The present subject matter also includes plasticizers that are 100% bio-based or substantially so. Cost concerns may favor the use of bio-based plasticizers that are less than 100% bio-based. However, for applications in which cost is not a concern, the bio-based plasticizer may be 100% bio-based or substantially so.

The following are representative examples of bio-based plasticizers that can be used in the films of the present subject matter. As will be understood, the one or more bio-based plasticizers are used in combination with one or more PLA resins. Table 1 sets forth three suitable bio-based plasticizers in accordance with the present subject matter. It will be appreciated that the present subject matter is not limited to any of these plasticizers and includes the use of one or more other plasticizers or bio-based plasticizers.

TABLE 1
Representative Bio-Based Plasticizers

| Trade Name | Supplier |
|---|---|
| DANISCO PL1886 | Danisco A/S, Brabrand, Denmark |
| | (now DuPont Co. of Wilmington, DE) |
| HALLGREEN ® R-8010 | Hallstar Company, Chicago, IL, USA |
| EDENOL 2166 | Emery Oleochemicals GmbH, |
| | Duesseldorf, Germany |

Details as to these bio-based plasticizers are as follows.

DANISCO PL1886 is an acetic acid ester/polyglycerol ester blend. The acetic acid ester component is an ester of monoglycerides of fatty acids. The polyglycerol ester component is an ester of fatty acids. More specifically, PL1886 is purportedly a blend of acetic acid ester of monoglycerides made from fully hydrogenated castor oil and polyglycerol ester made from edible, refined vegetable fatty acids.

HALLGREEN® R-8010 is a polymeric ester. Table 2 set forth below lists various physical properties of HALLGREEN® R-8010.

TABLE 2
Physical Properties of HALLSTAR ® R-8010

| Physical Property (Units) | Value |
|---|---|
| Acid Value, mg KOH/g | 0.55 |
| Appearance | Clear |
| Color, Gardner | 2.1 |
| Moisture, wt. % | 0.02 |
| Refractive index, 25° C. | 1.465 |
| Specific gravity, 25° C. | 1.176 |

EDENOL 2166 is an acetate ester. Table 3 set forth below lists various physical properties of EDENOL 2166.

TABLE 3
Physical Properties of EDENOL 2166

| Physical Property (Units) | Value | |
|---|---|---|
| Free acetic acid | 0-50 | ppm |
| Refractive index (20° C.) | 1.429-1.432 | |
| Water content (K. Fischer) | 0-0.2% | |
| Color (APHA) | 0-15 | |
| Viscosity (20° C.) | 21-24 | mPa's |

The present subject matter also includes the use of other plasticizers. Such plasticizers can be used instead of or in addition to the particular previously noted plasticizers. An example of another plasticizer is dioctyl adipate.

The compositions may optionally include one or more additional components and/or agents in addition to the PLA resin and the bio-based plasticizers. For example, the compositions can also comprise modifiers, nucleating agents, fillers, chain extenders, flame retardants, fragrances, UV stabilizers, antimicrobial agents, antioxidants, and combinations thereof.

The present subject matter also provides various multilayer assemblies of films comprising the compositions. For example, the present subject matter provides a multilayer assembly including a first layer comprising (i) PLA resin and (ii) one or more bio-based plasticizers, and a second layer comprising (i) PLA resin and (ii) one or more bio-based plasticizers. The multilayer assemblies in certain embodiments may additionally include a third layer comprising (i) PLA resin and (ii) one or more bio-based plasticizers. And, the multilayer assemblies in particular embodiments may also include additional layers. The composition of the layers are typically different from adjacent layers, however the present subject matter includes embodiments in which the layer compositions are identical or substantially so.

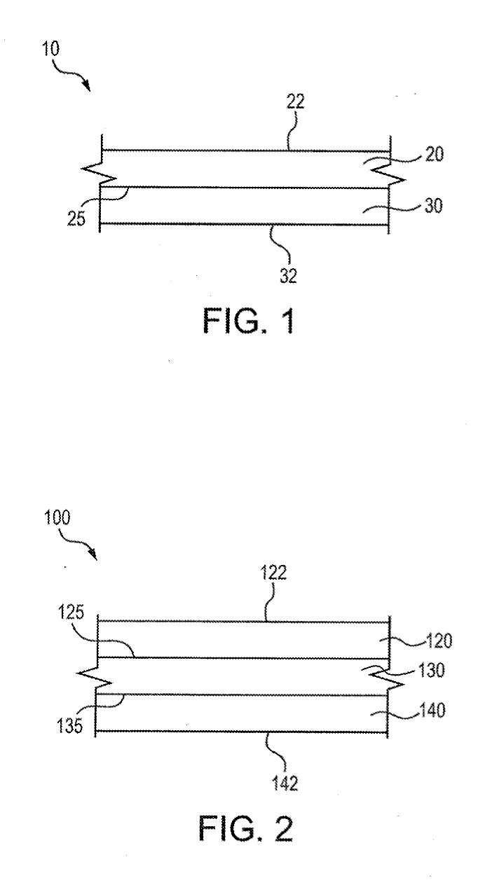

In certain versions of the present subject matter, particular core-skin multilayer assemblies are provided. For example, FIG. 1 schematically illustrates an assembly 10 comprising a skin layer 20 defining a first outer face 22 and an adjacent core layer 30 defining an oppositely directed second outer face 32. An interface 25 is defined between the skin layer 20 and the core layer 30. Each of the layers 20 and 30 comprises PLA resin and one or more bio-based plasticizers as described herein. FIG. 2 schematically illustrates an assembly 100 comprising a first skin layer 120 defining a first outer face 122, a second skin layer 140 defining a second and oppositely directed outer face 142, and a core layer 130 disposed between the skin layers 120, 140. An interface 125 is defined between the skin layer 120 and the core layer 130. Another interface 135 is defined between the skin layer 140 and the core layer 130. Each of the layers 120, 130, and 140 comprises PLA resin and one or more bio-based plasticizers as described herein. In certain embodiments, only one of the layers 120, 130, and 140 comprises PLA resin and one or more bio-based plasticizers. In other embodiments, two of the layers 120, 130, and 140 comprise PLA resin and one or more bio-based plasticizers.

In particular versions of the present subject matter, one or more antiblock agents are included in the film or layer. For multilayer assemblies and particularly for core-skin assemblies, one or more antiblock agents are incorporated in one or both of the outermost layers or skins. This is beneficial when producing roll form product because plasticized PLA can be or become, relatively tacky. A wide array of antiblock agents are commercially available. An antiblock agent available from A. Schulman of Akron, Ohio, under the designation PLA AB5 has been found to provide good antiblocking properties when used at a loading of 2% in each skin layer. It is contemplated that other loadings could be used in one or both skin layers such as for example from 0.1% or less, up to about 5% or more. The loadings of the antiblock agent(s) in each skin could be the same or different from one another.

Generally, the films of the present subject matter exhibit a unique combination of optical properties and flexibility. Typically, a layer or film in accordance with the present subject matter having a thickness of from 20 to 100 μm, and in certain embodiments from 35 to 75 μm, exhibits an optical haze of less than 10% as measured by ASTM D1003 and an optical clarity of greater than 90% as measured by ASTM D1003. In particular embodiments, such films exhibit an optical haze of from 0.1 to 8% and a clarity of from 92 to 99.9%. The noted films are also relatively flexible and exhibit a reduced bending stiffness as measured by ASTM D5342-93 when compared to corresponding films devoid of the bio-based plasticizers. In particular embodiments, the films of the present subject matter exhibit bending stiffness of less than 100 mN, and in certain embodiments, less than 90 mN, less than 80 mN, less than 50 mN, less than 25 mN, and in particular embodiments, less than 10 mN.

### Examples

Investigations were performed to assess various characteristics and physical properties of films in accordance with the present subject matter. In particular, optical characteristics and flexibility properties were measured of films corresponding to the present subject matter.

Table 4 lists various tests and corresponding standards describing the test or measurement procedure. The values or measurements reported herein were made in accordance with the procedures described in these test standards.

TABLE 4
Tests and Standards Utilized in Examples

| Test | ASTM | TAPPI |
|---|---|---|
| Tensile strength & elongation | D882 | T494M |
| Caliper (Emveco) | D2103 | T411 |
| Tear strength | D1004 | T414 |
| L&W bending stiffness | D5342-93 | T402 |
| Color (L-a-b) | D985 | T524 |
| Haze-clarity-transmission | D1003 | |
| Shrink | D2732-08 | |
| Dyne level (wetting tension) | D2578-67 | RC 359 VOl. 53, No. 6 |
| Opacity | D589 | T425 |
| Gloss (TAPPI = 20 deg) | D523-08 | T653 |
| COF | D1894-11e1 | T549 pm-90 |

| | |
|---|---|
| Curl | Internal |

Three sets of composition samples were prepared and formed into films. Each composition comprised either 85% or 90% PLA resin and either 10% or 15% DANISCO PL1886 bio-based plasticizer or 15% HALLGREEN® R-8010 bio-based plasticizer.

Tables 5-7 summarize the results of testing of these film samples. Table 8 lists various abbreviations.

TABLE 5
Testing Results of Films

| | Mod-MD | | UTS-MD | | | Mod-CD | | UTS-CD | | |
|---|---|---|---|---|---|---|---|---|---|---|
| Composition | psi | MPa | psi | MPa | El-MD, % | psi | MPa | psi | MPa | El-CD, % |
| PLA/10% Danisco | 293,012 | 2,020 | 6,930 | 48 | 291 | 242,891 | 1,675 | 6,713 | 46 | 4 |
| PLA/15% Danisco | 233,094 | 1,607 | 5,201 | 36 | 252 | 167,516 | 1,155 | 5,210 | 36 | 288 |
| PLA/15% | 422,376 | 2,912 | 9,003 | 62 | 4 | 352,839 | 2,433 | 8,838 | 61 | 3 |
| HalGreen R-8010 | | | | | | | | | | |

TABLE 6
Testing Results of Films

| | Tear, | | L&W, | | | | | Shrink, % | | |
|---|---|---|---|---|---|---|---|---|---|---|
| | gf/mil | | mN | | | 60° Gloss | | (70 C./24 h) | | |
| Composition | MD | CD | MD | CD | Haze | MD | CD | MD | CD | Dyne |
| PLA/10% Danisco | 26 | 35 | 62 | 61 | 1.2 | 70 | 76 | 11.8 | No | 41 |
| | | | | | | | | | shrink | |
| PLA/15% Danisco | 42 | 57 | 21 | 14 | 3.4 | 23 | 17 | 3.0 | 1.3 | 37 |
| PLA/15% | 20 | 25 | 85 | 79 | 1.3 | 134 | 123 | 5.2 | 0.8 | 41 |
| HalGreen R-8010 | | | | | | | | | | |

TABLE 7
Testing Results of Films

| | COF | | | | Film's | |
|---|---|---|---|---|---|---|
| | Pr-n/pr | | Pr-SS | | Caliper | |
| Composition | Static | Kinetic | Static | Kinetic | Mil | μm |
| PLA/10% Danisco | 0.52 | 0.25 | 0.22 | 0.15 | 2.42 | 61.5 |
| PLA/15% Danisco | 0.45 | 0.38 | 0.59 | 0.33 | 2.02 | 51.4 |
| PLA/15% HalGreen | 0.50 | 0.49 | 0.21 | 0.15 | 2.48 | 63.1 |
| R-8010 | | | | | | |

TABLE 8
Abbreviations

| | |
|---|---|
| MD - | machine direction |
| CD - | cross direction |
| Mod - | modulus |
| UTS - | ultimate tensile stress |
| El - | elongation |
| L&W - | bending stiffness |
| PR - | print |
| n/pr - | non-print |
| SS - | stainless steel |

Additional composition samples were prepared and formed into films. The compositions comprised 100%-80% PLA resin with 5%, 10%, 15%, and 20% EDENOL 2166 bio-based plasticizer. The sample containing 100% PLA resin without plasticizer is a control reference.

Tables 9 and 10 summarize the results of testing of these film samples.

TABLE 9
Testing Results of Films

| | Mod-MD | | UTS-MD | | | Mod-CD | | UTS-CD | | |
|---|---|---|---|---|---|---|---|---|---|---|
| Composition | psi | MPa | psi | MPa | El-MD, % | psi | MPa | psi | MPa | El-CD, % |
| PLA (4060D) | 213,788 | 1,474 | 5,318 | 37 | 340 | 136,470 | 941 | 5,023 | 35 | 382 |
| 5% Edenol 2166 | 114,075 | 787 | 5,028 | 35 | 340 | 110,596 | 763 | 5,362 | 37 | 383 |
| 10% Edenol 2166 | 1,488 | 10 | 2,061 | 14 | 138 | 1,331 | 9 | 2,512 | 17 | 189 |
| 15% Edenol 2166 | 1,127 | 8 | 1,715 | 12 | 148 | 1,172 | 8 | 1,977 | 14 | 166 |
| 20% Edenol 2166 | 274 | 2 | 641 | 4 | 320 | 424 | 3 | 729 | 5 | 347 |

TABLE 10
Testing Results of Films

| | | | L&W | | | | | | Film's | |
|---|---|---|---|---|---|---|---|---|---|---|
| | Tear, gf/mil | | mN | | | | 60° Gloss | | Caliper | |
| Composition | MD | CD | MD | CD | Haze, % | Clarity, % | MD | CD | Mil | μm |
| PLA (4060D) | 47 | 64 | 40 | 32 | 3.8 | 95 | 106 | 95 | 2.62 | 66.6 |
| 5% Edenol 2166 | 137 | 207 | 1.5 | 1.8 | 3.6 | 94 | 103 | 103 | 2.44 | 61.9 |
| 10% Edenol 2166 | 1,366 | 1,331 | n/a | n/a | 4.8 | 96 | 102 | 100 | 2.96 | 75.1 |
| 15% Edenol 2166 | 957 | 963 | n/a | n/a | 4.6 | 96 | 98 | 94 | 2.48 | 63.0 |
| 20% Edenol 2166 | n/a | n/a | n/a | n/a | 9.5 | 95 | 99 | 89 | 2.87 | 72.9 |

Additional composition samples were prepared and formed into films. The compositions comprised 80% or 90% PLA resin and 10% or 20% dioctyl adipate (DOA) plasticizer. Tables 11-13 summarize the results of testing of these film samples.

TABLE 11
Testing Results of Films

| | Mod-MD | | UTS-MD | | | Mod-CD | | UTS-CD | | |
|---|---|---|---|---|---|---|---|---|---|---|
| Composition | psi | MPa | psi | MPa | El-MD, % | psi | MPa | psi | MPa | El-CD, % |
| PLA/10% DOA | 282,742 | 1,949 | 6,481 | 45 | 290 | 214,232 | 1,477 | 5,000 | 34 | 3 |
| PLA/20% DOA | 218,755 | 1,508 | 5,358 | 37 | 220 | 172,068 | 1,186 | 4,320 | 30 | 4 |

TABLE 12
Testing Results of Films

| | Tear-MD, | Tear-CD, | L&W- | L&W- | | Gloss- | Gloss- | Shr- | Shr- | |
|---|---|---|---|---|---|---|---|---|---|---|
| Composition | gf/mil | gf/mil | MD, mN | CD, mN | Haze | MD | CD | MD, % | CD, % | Dyne |
| PLA/10% DOA | 12 | 27 | 13 | 11 | 2.5 | 65 | 56 | 10.7 | −1.00 | 38 |
| PLA/20% DOA | 38 | 69 | 15 | 7 | 1.8 | 68 | 90 | 6.4 | 1.51 | 33 |

TABLE 13
Testing Results of Films

| | | | | COF | | | | | |
|---|---|---|---|---|---|---|---|---|---|
| | Color | | | Pr-n/pr | | Pr-SS | | Caliper | |
| Composition | L | a | b | Static | Kinetic | Static | Kinetic | mil | μm |
| PLA/10% DOA | 88 | −1.1 | −0.3 | 2.4 | 1.6 | 0.4 | 0.3 | 1.52 | 38.6 |
| PLA/20% DOA | 89 | −1.1 | −0.6 | 2.6 | 2.4 | 2.0 | 0.8 | 2.10 | 53.3 |

As evidenced in the measured values, the films of the present subject matter exhibit a remarkable combination of optical clarity and flexibility.

Many other benefits will no doubt become apparent from future application and development of this technology.

All patents, published applications, and articles noted herein are hereby incorporated by reference in their entirety.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A multilayer film comprising:
a first layer including polylactic acid (PLA) resin and at least one bio-based plasticizer;
a second layer including polylactic acid (PLA) resin and at least one bio-based plasticizer.

2. The multilayer film of claim 1 further comprising:
a third layer including polylactic acid (PLA) resin and at least one bio-based plasticizer.

3. The multilayer film of claim 1 wherein at least one of the first layer, second layer, and third layer includes at least 70% of the PLA resin and 30% or less of the at least one bio-based plasticizer.

4. The multilayer film of claim 3 wherein the amount of the PLA resin in the layer is at least 75%.

5. The multilayer film of claim 4 wherein the amount of the bio-based plasticizer is 25% or less.

6. The multilayer film of claim 1 wherein the thickness of the multilayer film is from 20 to 100 μm.

7. The multilayer film of claim 1 wherein the optical haze of the multilayer film is less than 10%.

8. The multilayer film of claim 1 wherein the optical clarity of the multilayer film is greater than 90%.

9. The multilayer film of claim 1 wherein the bending stiffness of the multilayer film is less than 100 mN.

10. The multilayer film of claim 1 wherein the molecular weight of the PLA resin is between 10,000 and 500,000 g/mol.

11. The multilayer film of claim 1 wherein the bio-based plasticizer includes at least 50% of the plasticizer components derived from biological renewable sources.

12. The multilayer film of claim 1 wherein the bio-based plasticizer includes an acetic ester/polyglycerol ester blend.

13. The multilayer film of claim 1 wherein the bio-based plasticizer includes a polymeric ester having an acid value of 0.55 and a specific gravity of about 1.18.

14. The multilayer film of claim 1 wherein the bio-based plasticizer includes an acetate ester.

15. The multilayer film of claim 1 wherein the film includes dioctyl adipate.

16. The multilayer film of claim 1 wherein at least one of the first layer and the second layer also includes an antiblock agent.

17. The multilayer film of claim 16 wherein the antiblock agent is present in the respective layer at a loading from 0.1% to 5%.

18. The multilayer film of claim 16 wherein the film is in a roll form.

19. The multilayer film of claim 16 wherein the first layer is an outer skin layer and the first layer includes the antiblock agent.

20. A core-skin multilayer film comprising:
a first skin layer including polylactic acid (PLA) resin and at least one bio-based plasticizer;
a second skin layer including polylactic acid (PLA) resin and at least one bio-based plasticizer; and
a core layer disposed between the first skin layer and the second skin layer.

21. The core-skin multilayer film of claim 20 wherein at least one of the first skin layer and the second skin layer further include an antiblock agent.

22. The core-skin multilayer film of claim 21 wherein the first skin layer and the second skin layer include the antiblock agent.

23. The core-skin multilayer film of claim 21 wherein the antiblock agent is present in the respective skin layer at a loading of from 0.1% to 5%.

24. The core-skin multilayer film of claim 20 wherein at least one of the first skin layer, the second skin layer, and the core layer includes at least 70% of the PLA resin and 30% or less of the at least one bio-based plasticizer.

25. The core-skin multilayer film of claim 24 wherein the amount of the PLA resin in the layer is at least 75%.

26. The core-skin multilayer film of claim 25 wherein the amount of the bio-based plasticizer is 25% or less.

27. The core-skin multilayer film of claim 20 wherein the thickness of the multilayer film is from 20 to 100 μm.

28. The core-skin multilayer film of claim 20 wherein the optical haze of the multilayer film is less than 10%.

29. The core-skin multilayer film of claim 20 wherein the optical clarity of the multilayer film is greater than 90%.

30. The core-skin multilayer film of claim 20 wherein the bending stiffness of the multilayer film is less than 100 mN.

31. The core-skin multilayer film of claim 20 wherein the molecular weight of the PLA resin is between 10,000 and 500,000 g/mol.

32. The core-skin multilayer film of claim 20 wherein the bio-based plasticizer includes at least 50% of the plasticizer components derived from biological renewable sources.

33. The core-skin multilayer film of claim 20 wherein the bio-based plasticizer includes an acetic ester/polyglycerol ester blend.

34. The core-skin multilayer film of claim 20 wherein the bio-based plasticizer includes a polymeric ester having an acid value of 0.55 and a specific gravity of about 1.18.

35. The core-skin multilayer film of claim 20 wherein the bio-based plasticizer includes an acetate ester.

36. The core-skin multilayer film of claim 20 wherein the film includes dioctyl adipate.

37. The core-skin multilayer film of claim 20 wherein the film is in a roll form.
